(19) United States
(12) Patent Application Publication
(10) Pub. No.: US 2010/0153267 A1
(43) Pub. Date: Jun. 17, 2010

(54) OFF-LINE ACTIVATION/LOADING OF PRE-AUTHORIZED AND CLEARED PAYMENT CARDS

(76) Inventors: Shuan Ghaidan, Fairlight (AU); Robert White, Brentwood (GB); Robert Walls, Huntleys Cove (AU)

Correspondence Address: BUCKLEY, MASCHOFF & TALWALKAR LLC, 50 LOCUST AVENUE, NEW CANAAN, CT, 06840, US

(21) Appl. No.: 12/690,372

(22) Filed: Jan. 20, 2010

Related U.S. Application Data
(63) Continuation of application No. PCT/US2009/056902, filed on Sep. 15, 2009.
(60) Provisional application No. 61/097,781, filed on Sep. 17, 2008.

(51) Int. Cl. G06Q 40/00

(52) U.S. Cl. 705/41

(57) ABSTRACT

A method of loading pre-authorized funds into an integrated circuit (IC) payment card includes interfacing the IC payment card to a loading device. The method further includes receiving a cash payment to cover a proposed load transaction, and operating the loading device to load pre-authorized funds into the IC payment card on an off-line basis.

### CROSS-REFERENCE TO RELATED APPLICATIONS

This application claims the benefit of and is a continuation of PCT (International) patent application no. PCT/US2009/056902 filed Sep. 15, 2009; and also claims the benefit of U.S. provisional patent application Ser. No. 61/097,781, filed Sep. 17, 2008, which prior patent applications are incorporated herein by reference.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal. The authorization request is routed from the merchant's acquiring financial institution (“acquirer”) to a server computer operated by or on behalf of the issuer of the payment account. The issuer's server computer provides a response to the authorization request. If the response indicates that the issuer has authorized the transaction, the transaction is consummated at the point of sale. Later the transaction is cleared for settlement via the acquirer and the issuer.

More recently, cards that incorporate an integrated circuit (IC) have been utilized as payment cards. One well known IC payment card standard is referred to as “EMV”, and utilizes an IC card (also known as a “smart card”) that is interfaced to a POS terminal via contacts on the IC card. During a purchase transaction, the payment card account number and other information may be uploaded from the IC payment card to the POS terminal via the IC card contacts and a contact card reader that is included in the POS terminal. Authorization and clearing may then proceed in substantially the same manner as for a transaction initiated with a mag stripe payment card (putting aside additional security measures that may be implemented by using the processing capabilities of the IC payment card and chip data in the clearing).

In other IC payment card systems, the exchange of information between the card and the POS terminal proceeds via wireless RF (radio frequency) communications. These wireless communication payment cards are sometimes referred to as “contactless” payment cards. One example of a contactless payment card standard is referred to in the United States by the brand name “PayPass” and was established by MasterCard International Incorporated, the assignee hereof.

In addition to debit and credit IC payment cards, there are also so-called “pre-authorized” cards. These cards are not necessarily linked to a credit card account or to a bank account from which debits are made via the payment card system. Rather, pre-authorized cards are loaded (“topped-up”) from time to time with monetary value, and the cards are used to make purchases based on deductions from the value stored in the cards. The resulting purchase transactions may be referred to as “off-line purchase transactions” in the sense that the POS terminal does not request an on-line authorization from the card issuer computer before the purchase transaction is consummated. Merchants that accept pre-authorized cards may submit purchases transactions for subsequent clearing against a “shadow account” for the pre-authorized card via the clearing system operated by the payment card system.

When it is necessary to top-up a pre-authorized card, the card may be interfaced to a terminal or kiosk, typically via a contact interface. The user may interact with the terminal to obtain authorization from a central server to have more monetary value loaded into the pre-authorized card.

In contradistinction to “off-line” purchase transactions, as described in the previous paragraph, conventional payment system purchase transactions that require real-time online communication with the account issuer—for the purpose of authorization or (in a “one message” system) for immediate charge against the customer's account—may be referred to as “online purchase transactions”.

To the extent that a payment device is used for off-line, pre-authorized purchase transactions, it in effect functionally mimics a pre-paid or stored value card, at least in terms of what occurs at the point of sale.

The present inventors now disclose herein certain techniques that may facilitate operation of a payment system that supports pre-authorized and cleared payment cards.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that schematically illustrates major components of a payment card system in which the present invention may be applied.

FIG. 2 is a block diagram that schematically illustrates an off-line load transaction provided in accordance with aspects of the present invention.

FIG. 3 is a block diagram that schematically illustrates an on-line load transaction provided in accordance with aspects of the present invention.

FIG. 4 is a block diagram that schematically illustrates a typical purchase transaction performed in the system of FIG. 1.

FIG. 5 is a block diagram that schematically illustrates another example of a purchase transaction that may be performed in the system of FIG. 1 in accordance with aspects of the present invention.

FIG. 5A is a block diagram that schematically illustrates transaction clearing and other functions of the system of FIG. 1.

FIG. 6 is a high-level functional block diagram that illustrates a cash card system host computer that is part of the system of FIGS. 1 and 5A and that is provided in accordance with aspects of the present invention.

FIG. 7 is another block diagram representation of the cash card system host computer shown in FIG. 6.

FIG. 8 schematically illustrates hardware aspects of a typical IC card used as a payment card in the system of FIG. 1.

FIG. 9 is a high-level functional block diagram representation of a typical POS terminal or load terminal that is included in the system of FIG. 1.

FIG. 10 is a functional block diagram that schematically illustrates management of data encryption keys in the system of FIG. 1 in accordance with aspects of the present invention.

FIG. 11 is a flow chart that illustrates an off-line load process that may be performed in the system of FIG. 1 in accordance with aspects of the present invention.

FIG. 12 is a flow chart that illustrates some details of the process of FIG. 11.

FIG. 13 is a flow chart that illustrates an on-line load process that may be performed in the system of FIG. 1 in accordance with aspects of the present invention.

FIG. 14 is a flow chart that illustrates some details of the process of FIG. 13.

FIG. 15 is a flow chart that illustrates aspects of the on-line load process as performed by the cash card system host computer in accordance with aspects of the present invention.

FIG. 16 is a flow chart that illustrates a link update process that may be performed in the system of FIG. 1 in accordance with aspects of the present invention.

FIG. 17 is a flow chart that illustrates aspects of the link update process as performed by the cash card system host computer in accordance with aspects of the present invention.

FIG. 18 is a flow chart that illustrates a process for a typical off-line purchase transaction performed in the system of FIG. 1.

FIG. 19 is a flow chart that illustrates a process for clearing transactions performed by the cash card system host computer.

### DETAILED DESCRIPTION

In general, and for the purpose of introducing concepts of embodiments of the present invention, a system for pre-authorized and cleared payment cards supports off-line activation and/or loading of the payment cards. (Hereinafter, pre-authorized and cleared payment cards may sometimes be referred to as “cash cards”.) In off-line loading transactions, a load device is interfaced to the cash card and loads additional pre-authorized funds therein without interacting with the issuer of the cash card during the transaction or with any other remote component of the cash card system.

The cash card system may also support on-line load transactions, in which the load device interacts with a central computer.

In off-line load transactions, the load of funds into the cash card may be implemented with a script that is generated locally by the load device and transmitted to the cash card by the load device for execution by the cash card. In on-line load transactions, the load of funds into the cash card may be implemented with a script that is generated remotely by a central computer and then transmitted to the cash card via the load device.

In on-line load transactions the script may be encrypted with a first IC master key at the central computer. In off-line load transactions, the script may be encrypted with a second IC master key at the load device.

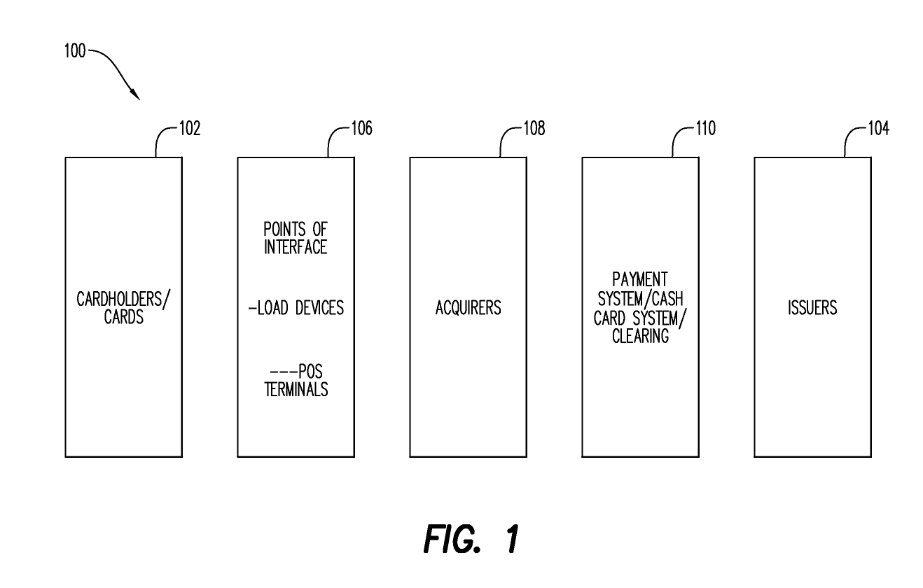

FIG. 1 is a block diagram that schematically illustrates major components of a payment card system 100 in which the present invention may be applied.

Block 102 in FIG. 1 represents consumers/cardholders and the cash cards that they carry for use with the payment card system 100.

Block 104 in FIG. 1 represents financial institutions that issue the cash cards.

Block 106 in FIG. 1 represents so-called “point of interface” (POI) devices such as POS terminals or load devices. The POI devices may be present at retail stores and/or bank branches and may be suitable for having cash cards interfaced thereto for the purpose of performing purchase transactions and/or load transactions.

Block 108 in FIG. 1 represents financial institutions (“acquirers”) that have relationships with merchants or service providers and that provide a connection between the POI devices and the payment card system at large.

Block 110 represents centralized and/or network components of the payment card system such as may be operated by or on behalf of a payment card association such as the assignee hereof. Components represented by block 110 may include (a) a transaction routing system such as the well-known “Banknet” system operated by the assignee hereof, (b) a transaction clearing system such as the “Global Clearing Management System” (GCMS) operated by the assignee hereof, and (c) a cash card system host computer as described below.

The left-to-right arrangement of blocks 102, 106, 108, 110 and 104 is intended to suggest a general transaction flow from card/cardholder, through POI device, acquirer and network to the issuer. More detailed transaction flows for various types of transactions will be described below in conjunction with other drawings.

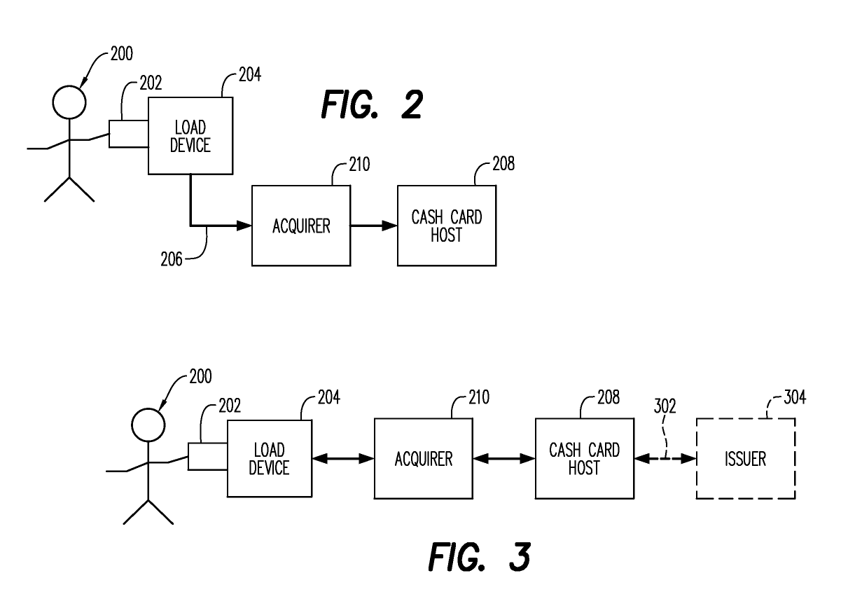

FIG. 2 is a block diagram that schematically illustrates an off-line load transaction provided in accordance with aspects of the present invention.

In FIG. 2, a cardholder 200 is shown interfacing a cash card 202 to a load device 204 for the off-line load transaction. The purpose of this transaction is to increment the pre-authorized balance stored in the cash card 202 so that the cash card 202 may be used for subsequent off-line purchase transactions. Typically, the load transaction is funded by the cardholder 200 delivering cash to an attendant (not shown) who operates the load device 204 and who may be, for example, a bank employee or a retail store employee. The amount of cash delivered by the cardholder 200 may be sufficient to cover the amount loaded into the cash card 202 plus a transaction fee.

At 206 in FIG. 2 a signal path is indicated by which (e.g., via a batch process) the load device 204 subsequently notifies a cash card system host computer 208 of the load transaction via an acquiring financial institution (acquirer) 210. Based on the notification, the cash card system host computer 208 updates a clearing file for the cash card 202 to be used for the subsequent purchase transactions made with the cash card 202. During the load transaction itself, the load device 204 is not in communication with any remote device. In a subsequent clearing transaction (not illustrated in FIG. 2), the amount of the load is cleared from the account of the merchant (or other entity) which operates the load device via the payment card system to the issuer of the cash card 202.

In some cases the load transaction illustrated in FIG. 2 may also include initial activation of the cash card 202. For example, the merchant may have a supply of unactivated cash cards on hand available for purchase and loading by would-be cardholders. The load device 204 may operate to activate the card in addition to performing the initial load, and may notify the cash card system host computer 208 of activation of the cash card 202 in addition to providing notification to the cash card system host computer 208 of the load transaction.

One advantage of the off-line nature of the load transaction is that it may in some cases be performed at a temporary merchant location, on a cruise ship or at some other location which lacks infrastructure to support real-time on-line communication with the payment card system/card issuer/cash card system host computer 208 and/or in situations where the permitted time for the transaction is short.

FIG. 3 is a block diagram that schematically illustrates an on-line load transaction provided in accordance with aspects of the present invention.

As in FIG. 2, FIG. 3 again shows the cardholder 200 interfacing the cash card 202 to a load device 204. However, in the load transaction illustrated in FIG. 3, the load device 204 is in on-line communication during the transaction with the cash card system host computer 208 via the acquirer 210. The on-line load transaction shown in FIG. 3 may be funded by a cash payment from the cardholder 200, as in the off-line load transaction shown in FIG. 2. Alternatively, in a case where the cash card 202 is linked to a bank account/credit card account owned by the cardholder 200, then the funding may come from the linked account via a funding transaction (indicated at 302) with the card issuer (issuing financial institution) 304.

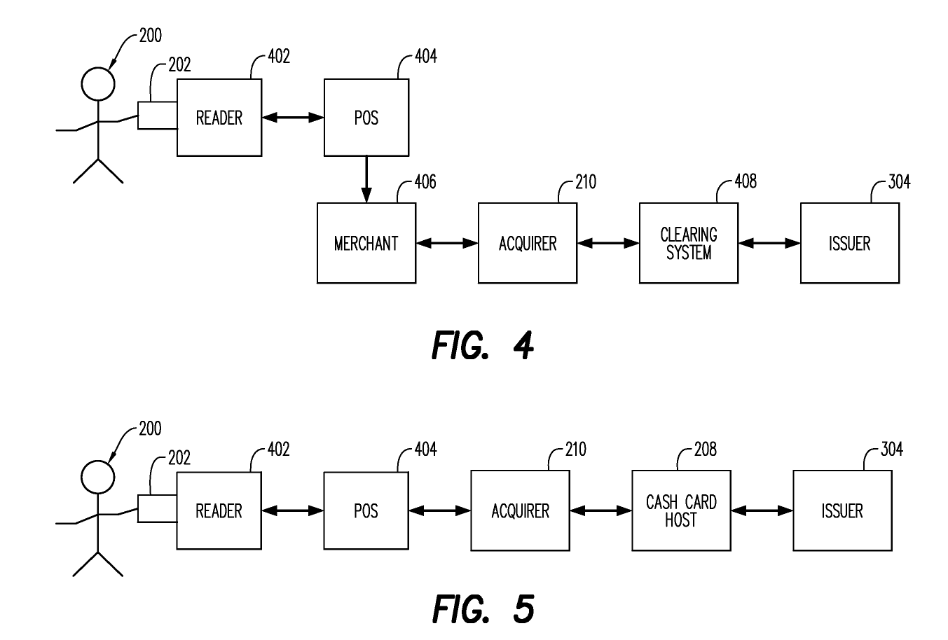

FIG. 4 is a block diagram that schematically illustrates a typical purchase transaction performed in the payment card system 100.

FIG. 4 shows the cardholder 200 interfacing the cash card 202 to the reader component 402 (proximity or contact reader) of a POS terminal 404. Subsequently, the transaction is cleared from the issuer 304 via the merchant's computer 406, the acquirer 210 and a clearing system 408. The purchase transaction itself is handled on an off-line basis, with clearing later handled in a batch mode (e.g., at the end of the day).

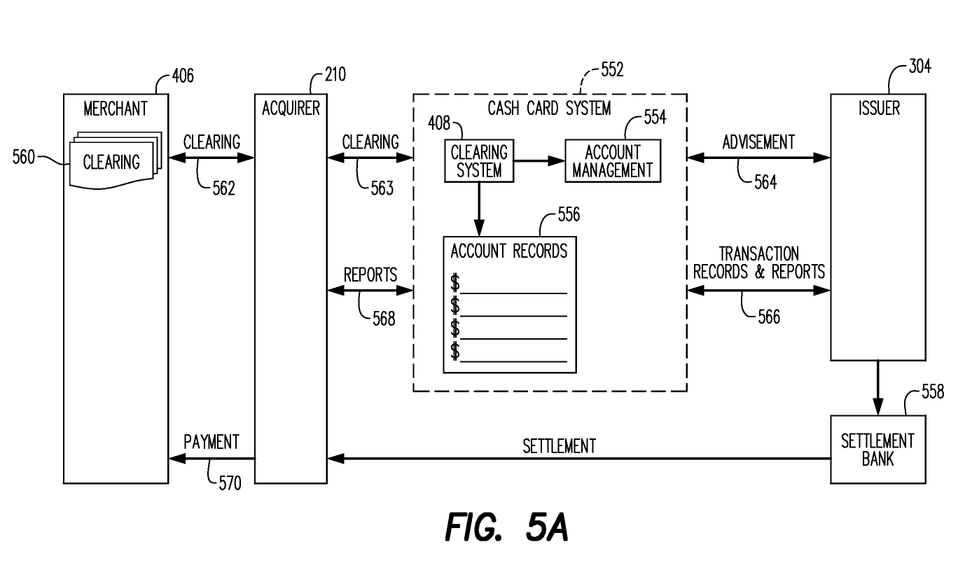

FIG. 5 is a block diagram that schematically illustrates another example of a purchase transaction that may be performed in the payment card system 100 in accordance with aspects of the present invention. For purposes of FIG. 5, it is assumed that the purchase transaction is in an amount that exceeds the current pre-authorized balance in the cash card 202, so that an on-line load transaction is also included to allow the purchase transaction to go through. It is further assumed for purposes of FIG. 5 that the POS terminal 404 has capabilities for on-line real-time communication with the acquirer 210.

Thus FIG. 5 again shows the cardholder 200 interfacing the cash card 202 to the reader component 402 of the POS terminal 404. Authorization for the load transaction proceeds by request from the POS terminal 404 to the cash card system host computer 208 via the acquirer 210. Authorization for funding of the load transaction from a linked account proceeds by request from the cash card system host computer 208 to the issuer 304. The purchase transaction itself may be subsequently cleared via the pathway illustrated in FIG. 4.

FIG. 5A is a block diagram that schematically illustrates transaction clearing and other functions of the payment card system 100.

FIG. 5A shows the merchant computer 406 in communication with the acquirer (acquirer computer) 210. Block 552 in FIG. 5A represents central cash card system components, including the clearing system 408, a cash card account management system 554 and an account record data store 556. (In some embodiments, the central cash card system components 552 may at least partly be constituted by the cash card system host computer 208 shown in FIGS. 2 and 3.) The central cash card system components 552 are in communication with the acquirer computer 210 and with the issuer (issuer computer) 304. Also shown in FIG. 5A is a settlement bank 558, which serves as a conduit for settlement of the clearing transactions from the issuer 304 to the acquirer 210.

Although only one merchant, one acquirer and one issuer are shown in FIG. 5A (all assumed to be involved with a single clearing transaction), in practice the payment card system 100 may include numerous merchants, as well as a considerable number of acquirers and issuers. Financial institutions that serve as acquirers for some transactions may also act as issuers with respect to other transactions. A given acquirer may serve numerous merchants.

As seen from FIG. 5A, a clearing file 560 generated in the merchant computer 406 is communicated from the merchant computer 406 to the acquirer computer 210 via an exchange of clearing messages indicated at 562. Further clearing messages are exchanged at 563 between the acquirer computer 210 and the clearing system 408. Clearing of the transaction is reflected for the cash card in question in the card account management system 554. A record of the transaction is kept in account record data store 556. The issuer 304 is advised of the clearing transaction by the card account management system 554 in advisement communications 564. Transaction records and reports are made available to the issuer 304 from the account record data store 556 as indicated at 566. Reports of clearing activities are also made available from the account record data store to the acquirer 210, as indicated at 568. Upon settlement of the clearing transaction, payment for the underlying purchase transaction is made from the acquirer 210 to the merchant 406, as indicated at 570.

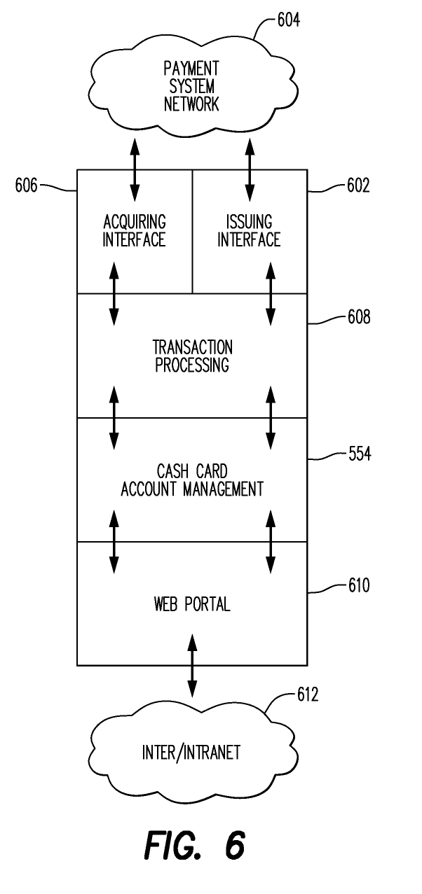

FIG. 6 is a high-level functional block diagram that illustrates an embodiment of a cash card system host computer 208 that is part of the payment card system 100 and that is provided in accordance with aspects of the present invention.

Block 602 in FIG. 6 represents an aspect of the cash card system host computer 208 which functions as an interface with respect to requests for which the cash card system host computer 208 acts in an issuer mode. These requests are received by the cash card system host computer 208 via the payment system network 604 and may include, for example, requests for scripts to load funds into cash cards. These requests may have originated, for example, from load devices as referred to above. It will be noted that this issuer interface 602 couples the cash card system host computer 208 to the payment system network 604.

Block 606 in FIG. 6 represents an aspect of the cash card system host computer 208 which functions as an interface with respect to requests that the cash card system host computer 208 generates in its role as an acquirer. Typically, these requests are for the purpose of requesting funding transactions from credit or debit accounts that are linked to cash cards. These requests are dispatched by the cash card system host computer 208 via the payment system network 604 and are routed via the payment system network 604 to the issuer of the cash card and the linked credit/debit account. Like the issuer interface 602, the acquirer interface 606 couples the cash card system host computer 208 to the payment system network 604.

Block 608 in FIG. 6 represents transaction processing capabilities of the cash card system host computer 208 and is functionally linked to the interfaces 602, 606. The transactions processed by block 608 may include load requests, outgoing funding requests in the case of linked load transactions, and clearing of purchase transactions.

Block 554 in FIG. 6, like the block bearing the same reference numeral in FIG. 5A, represents a card account management system. The card account management system 554 supports “shadow accounts” for the individual cash cards. These shadow accounts reflect fund loads into the cash cards and purchase transactions by the cash cards, and are utilized for clearing the purchase transactions. The cash card system illustrated herein is a fully accounted system, and the card account management system 554 is the vehicle for the requisite accounting. It will be noted that the card account management system 554 is functionally coupled to the transaction processing block 608 of the cash card system host computer 208.

Block 610 in FIG. 6 represents capabilities of the cash card system host computer 208 for hosting a web portal, and is coupled to a data network such as an intranet or the Internet (indicated by reference numeral 612). Web portal block 610 is also functionally coupled to the card account management system 554. The web portal provided by block 610 is a vehicle for providing reports to acquiring and issuing financial institutions that participate in the cash card system. In some embodiments, the web portal also facilitates customer service provided directly to cardholders.

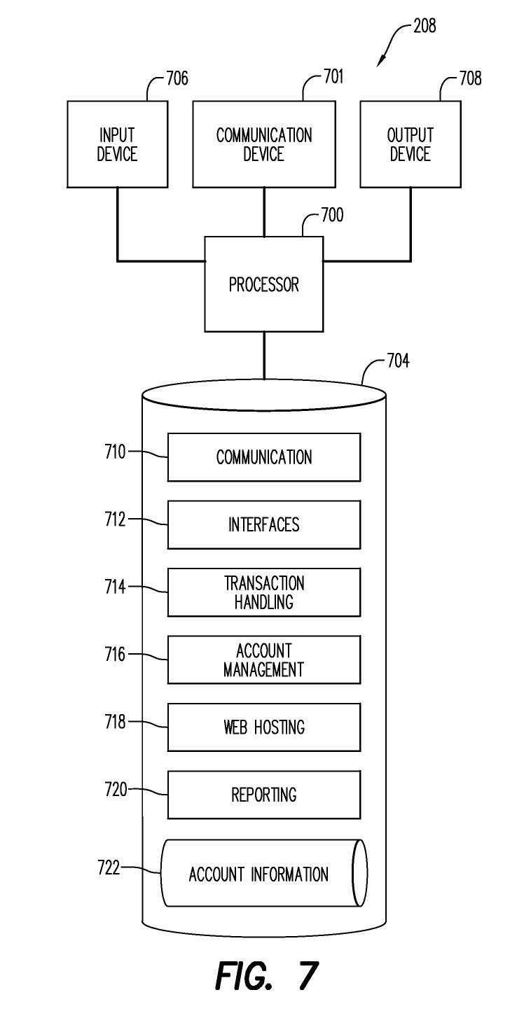

FIG. 7 is another block diagram representation of the cash card system host computer 208, showing in particular some hardware and software aspects of the cash card system host computer 208.

The cash card system host computer 208 may be conventional in its hardware aspects but may be controlled by software to cause it to function as described herein. For example, the cash card system host computer 208 may be constituted by conventional server computer hardware.

The cash card system host computer 208 may include a computer processor 700 operatively coupled to a communication device 701, a storage device 704, an input device 706 and an output device 708.

The computer processor 700 may be constituted by one or more conventional processors. Processor 700 operates to execute processor-executable steps, contained in program instructions described below, so as to control the cash card system host computer 208 to provide desired functionality.

Communication device 701 may be used to facilitate communication with, for example, other devices (such as the payment system network, acquirer computers and issuer computers). For example, communication device 701 may comprise numerous communication ports (not separately shown), to allow the cash card system host computer 208 to communicate simultaneously with a number of other computers or other devices.

Input device 706 may comprise one or more of any type of peripheral device typically used to input data into a computer. For example, the input device 706 may include a keyboard and a mouse. Output device 708 may comprise, for example, a display and/or a printer.

Storage device 704 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 704 stores one or more programs for controlling processor 700. The programs comprise program instructions (which may be referred to as computer readable program code means) that contain processor-executable process steps of the cash card system host computer 208, executed by the processor 700 to cause the cash card system host computer 208 to function as described herein.

The programs may include a communication application 710 that controls the processor 700 to enable the cash card system host computer 208 to engage in data communication with other computers in a conventional manner. The programs may further include programs (represented by block 712) for implementing the acquirer and issuer interfaces referred to above in connection with FIG. 6. These interfaces may, for example, be implemented generally in accordance with conventional practices related to acquirer and issuer messaging interfaces for payment systems.

The programs stored in the storage device 704 may also include a transaction handling application 714 that controls the processor 700 to enable the cash card system host computer 208 to handle various transactions, including load requests, clearing of purchase transactions by cash cards, and initiating authorization requests for funding of linked load requests.

Another program that may be stored on the storage device 704 is an account management application 716. The account management application 716 implements the card account management system that was referred to above.

The programs stored on the storage device 704 may further include a web hosting program 718 which implements the web portal referred to above in connection with FIG. 6. In addition, the programs stored on the storage device 704 may include a reporting program 720 which generates reports to be provided by the cash card system host computer 208 to acquirer and issuer computers and possible for other purposes as well.

Block 722 in FIG. 7 represents a database of information relating to the cash card accounts managed via the cash card system host computer 208.

The storage device 704 may also store, and the cash card system host computer 208 may also execute, other programs, which are not shown. The other programs may include, e.g., one or more conventional operating systems, device drivers, etc. The storage device 704 may also store data required for operation of the cash card system host computer 208 in addition to the account information database 722 referred to above. The other data may include, for example, a database relating to transactions handled by the cash card system host computer 208.

Although only a single cash card system host computer 208 has been referred to up to now, it should be understood that the functions performed by the cash card system host computer 208 may in practice be divided among two or more cooperating computer systems. Accordingly, when the term “computer” is used herein or in the appended claims, that term should be understood to include one computer or two or more cooperating computers. Similarly, the term “processor” should be understood to include one processor or two or more cooperating processors.

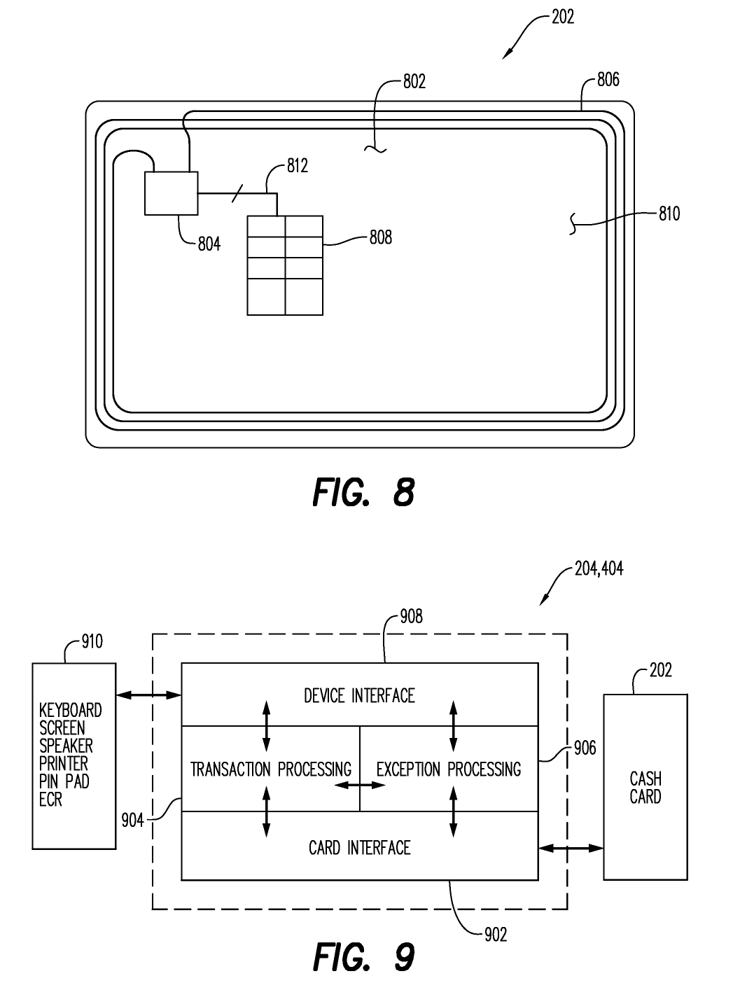

FIG. 8 schematically illustrates hardware aspects of a typical IC card used as a cash card 202 in the payment card system 100. The cash card 202 may include a card-shaped body 802, which may resemble conventional payment cards in shape and size. The card-shaped body 802 may be formed of plastic or another suitable material.

The cash card 202 may also include an IC 804. The IC 804 may be mounted and/or installed in any suitable manner in the card-shaped body 802. For example, the IC 804 may be embedded (partially or completely) in the card-shaped body 802. The IC 804 may be suitably designed and configured to transmit cash card account information by radio frequency signaling and/or via a contact data signal path to a POS terminal. The cash card 202 may further include an antenna 806 embedded in or otherwise mounted on the card-shaped body 802. As shown, the antenna 806 may be in the form of several loops arranged along the periphery of the card-shaped body. Alternatively, the antenna 806 may be of a different type and/or configuration. The antenna may be operative generally in accordance with a known standard for contactless IC cards to receive interrogation and power signals (which may be the same signal) from a proximity coupling device of a POS terminal and to transmit cash card account number information and/or other information to the proximity coupling device.

In addition, the cash card 202 may include a set of conductive contacts 808 located on a front surface 810 of the card-shaped body 802. The contacts may be coupled to the IC 804 via a suitable arrangement of signal path connections indicated at 812. The contacts 808 may be positioned and laid out on the cash card 202 in accordance with a well-known standard for contact IC cards.

It will be appreciated that the cash card 202 is operable as both a contactless and a contact IC card. The IC 804 may be designed and configured to operate in accordance with an appropriate standard for IC cards, such as the above-mentioned EMV standard.

In some embodiments, lettering (not shown) or other symbols (not shown) may be present on the front surface 810 of the card-shaped body 802 and/or on the rear surface (not shown) of the card-shaped body 802. Still further, the front surface 802 of the card-shaped body 102 may carry one or more logos and/or brands, including for example the brand/logo of a payment card association such as MasterCard International Incorporated. The brand/logo of the issuer may also be present, as well as, for example, a specific card product brand. In addition, the cash card 202 may include other features commonly found on a payment card. In some embodiments, the IC 804 may be programmed and/or configured to allow the cash card 202 also to operate as a conventional debit or credit card for conventional transactions that access a payment card account that is different from the shadow account for the cash card 202. That is, for conventional credit and/or debit card purchase transactions, the cash card 202 (in functioning as a credit or debit card) may transmit a payment card account number other than the account number that is associated with the cash card 202 in its role in the cash card system.

In some embodiments, the cash card 202 may also include a conventional magnetic stripe (not shown). With this feature the cash card 202 may be usable as a conventional mag stripe debit or credit card, in addition to its functions for the pre-authorized, cleared payment applications described herein.

FIG. 9 is a high-level functional block diagram representation of a typical POS terminal 404 or load terminal 204 that is included in the payment card system 100. Either or both of these devices may be referred to generically as a “point of interaction” (POI) device.

One element of the POI device depicted in FIG. 9 is a card interface, represented by block 902. The card interface 902 may, for example, take the form of a conventional RF (contactless) interface and/or a conventional contact interface for an IC card. In some embodiments, purchase transactions may be performed via either a contact or a contactless I/F, whereas it may be desirable to perform load transactions only via a contact I/F. That is, due to the potentially longer-duration required interaction between the cash card 202 and the POI device during a load transaction, it may be best if the contact I/F were used to assure that the communication channel between the POI device and the cash card 202 remains unbroken while the load transaction takes place.

Block 904 in FIG. 9 represents transaction processing capabilities of the POI device. It will be observed that transaction processing block 904 is coupled to the card interface 902. Information exchanged with the cash card 202 via the card interface 902 may be received by the transaction processing block 904 or may have been generated by the transaction processing block 904. Some operations of the transaction processing block 904 may be conventional, such as those involved in handling a typical purchase transaction. Other aspects of operations of the transaction processing block 904, including particularly operations related to load transactions, are described further below.

Block 906 in FIG. 9 represents exception handling capabilities of the POI device. The exception handling block 906 is coupled to the card interface 902 and to the transaction processing block 904. The exception handling block 906 operates to provide suitable responses when a transaction or sequence of communications with the cash card 202 does not go as expected. Examples of situations that call for exception handling may include presentation of a cash card that has expired, or an unexpected interruption of the communications with the cash card 202.

Block 908 in FIG. 9 represents the aspects of the POI device that manage interaction with peripheral devices (e.g., user interface devices), such as a keyboard, a display screen (and/or touch screen), a speaker, a printer, a PIN (personal identification number) entry pad, and/or an electronic cash register (ECR). (Collectively, these peripheral devices are indicated by block 910 in FIG. 9.) In general, the peripheral device interface 908 may operate in accordance with conventional principles.

At least some of the functional blocks shown in FIG. 9 may be implemented by a processor (not separately shown) in communication with a memory (not separately shown) and operating under the control of software and/or firmware instructions stored in the memory.

The POI device may also be referred to as a “load device” and may be embodied as a POS terminal, an ATM, an AVM, or a kiosk, or any other device configured to interact with a physically-present cash card.

In software terms, a payment application kernel in the POI device may interact with a terminal application manager in the POI device via an abstraction layer. The terminal application manager may drive the user interface of the POI device and manage payment kernel processing and send instructions to one or more payment kernels in the POI device. The payment kernel(s) may interface to the cash card. The payment kernel(s) may, for example, operate in accordance with the EMV standard, apart from functionality described herein to implement the pre-authorized and cleared payment loads.

In some embodiments, the POI device may include hardware and/or software features that render the POI device tamper-proof and that cause the encryption keys to be destroyed if tampering is attempted. These features are not separately indicated in the drawing and may be implemented in accordance with conventional practices.

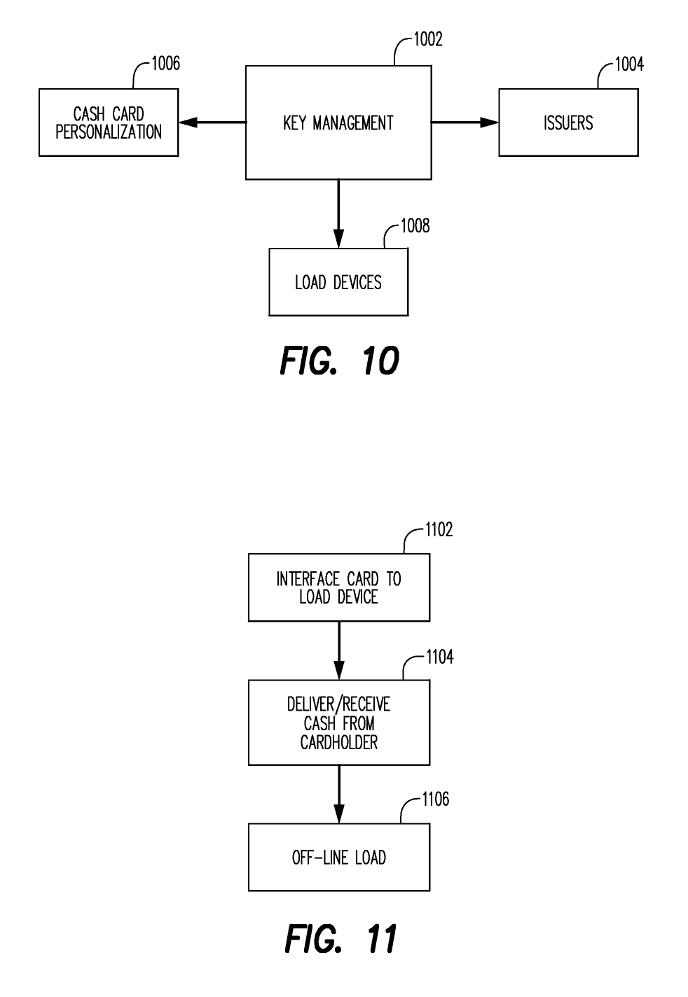

FIG. 10 is a functional block diagram that schematically illustrates management of data encryption keys in the payment card system 100.

In FIG. 10, block 1002 represents a central encryption key management authority, which may for example be the sponsor (e.g., a payment card association such as the assignee hereof) of the cash card system. The central encryption key management authority 1002 may have overall control of the encryption keys utilized in connection with loading of cash cards and/or other operations related to cash cards. In accordance with conventional practices, each issuer (block 1004) may be provided with an issuer master encryption key. ICC (integrated circuit card) master keys may be derived from the issuer master key and stored securely via a personalization process (block 1006) on the cash cards. During online load operations, the issuer builds a secure message using a session key derived from the relevant ICC master key. When the cash card receives the message, the cash card derives the same session key, in order to authenticate the message and execute a script to reload the cash card. In some embodiments, at least some of the issuer functions related to on-line load transactions may be performed by the cash card system host computer 208 on an “on behalf” basis for the actual issuer of the cash card.

To facilitate off-line load/card activation transactions, and in accordance with aspects of the present invention, a common second set of ICC master keys may be stored on every cash card and on every load device (or at least on every load device that performs off-line load transactions). (The load devices are represented at block 1008 in FIG. 10.) When this second master key is used, it is referenced via a key derivation index passed from the cash card that is being loaded to the load device. The key derivation index can point to a number of keys. The load device builds a secure message using a session key derived from the off-line master key as referenced by the key derivation index. The secure message includes a script to be executed by the cash card, and the secure message is transmitted to the cash card from the load device. The cash card authenticates the session key and executes the script to accomplish the desired load transaction.

In both on-line and off-line loads, the session key may be derived from the master key (either on-line or off-line) using, for example, the cash card PAN (primary account number), the PAN sequence number and a random number or any partial combination thereof and other elements as necessary.

To reduce any risk of attempts to compromise the off-line load process, the off-line master keys may be stored securely in the load devices in hardware security modules and derived keys. For example, the load devices may be made tamper-resistant. The type of encryption used may be strong, such as double length DES (Data Encryption Standard) encryption.

Even if a wrongdoer were able to work out the off-line master key, the wrongdoer would still have to build his/her own counterfeit load device and attempt to use it to perform loads on cash cards. There may be features in the system that would mitigate any risks of this type of attack. For example, the cash card system is “closed loop” in the sense that all loads and purchase transactions are accounted for. Spurious loads would quickly be detected during reconciliation of card account records. This process would reveal the numbers (PANs) of any cards that were spuriously loaded.

Further, the comprised off-line master key could be disabled and the key derivation index changed. The compromised key would no longer work for load operations, and legitimate cards would continue to work.

Other risk mitigation measures that may be undertaken may include blocking compromised cards via a blacklist process, limiting load amounts per day per card to US$300 or another suitable amount, and limiting use of cash cards to the country in which they are issued.

FIG. 11 is a flow chart that illustrates an off-line load process that may be performed in the payment card system 100 in accordance with aspects of the present invention.

At 1102 in FIG. 11 (and referring also to FIG. 2), the cardholder 200 interfaces the cash card 202 to the load device 204. As noted above this may be done via the contacts 808 (FIG. 8) on the cash card 202 and via the card interface 902 (FIG. 9) of the load device 204. It should also be noted that instead of the cardholder interfacing the cash card 202 to the load device 204, this action may be performed by an employee (not shown) of a merchant, bank or service provider.

At 1104 in FIG. 11, the cardholder 202 delivers and the merchant/bank/service provider employee receives cash to cover the requested amount of the desired load transaction. (It will be evident that step 1104 may be performed prior to step 1102.)

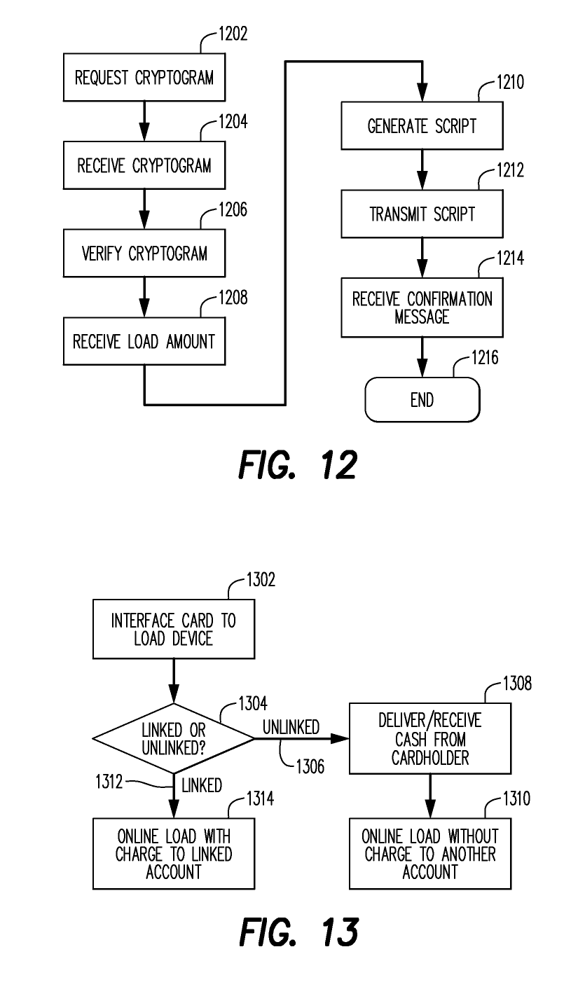

Next, at 1106, an off-line load transaction is performed, as described in more detail below in conjunction with FIG. 12. (FIG. 12 is a flow chart that illustrates some details of step 1106.) It should be understood that the process of FIG. 12 may be initiated by the employee providing suitable input to the load device 204, such as selecting an “off-line load” option from a menu (not shown).

At 1202 in FIG. 12, the load device 204 sends a message to the cash card 202, requesting that the cash card 202 provide a cryptogram to the load device 204 to verify the authenticity of the cash card 202. At 1204, the load device 204 receives the cryptogram from the cash card 202. At 1206, the load device 204 verifies the cryptogram.

The generation and verification of the cryptogram may be performed in accordance with conventional security practices employed in connection with “topping-up” pre-authorized payment cards. In verifying the cryptogram, the load device 204 may perform a cryptographic calculation to produce a result that is supposed to match the cryptogram received from the cash card 202. If the result of the cryptographic calculation by the load device matches the cryptogram received from the cash card 202, then the cryptogram is considered to have been verified. It will be understood that the same cryptographic calculation process had been performed by the cash card 202 to generate the cryptogram. (For the purposes of this example, it will be assumed that the cryptogram is verified. If such is not the case, the process may proceed, by a branch not shown in the drawing, to a suitable exception handling process, and the load transaction is aborted.) The receipt and verification of the cryptogram produced by the cash card 202 may be considered a technique for authenticating the cash card 202.

At 1208 in FIG. 12 (i.e., following verification of the cryptogram), the load device 204 receives input from the operator (i.e., the employee of the merchant/bank/service provider) to indicate the amount of pre-authorized funds to be loaded into the cash card 202. Presumably, this amount reflects the amount of cash tendered by the cardholder. (In other embodiments, input of the amount to be loaded may occur prior to or overlapping in time with the steps illustrated at 1202-1206.)

Next in the process is step 1210. At 1210, the load device 204 generates a script that is to be executed by the cash card 202 to implement the desired load of pre-authorized funds into the cash card 202. In some embodiments, the load device 204 may generate the script in a manner similar to generation of top-up scripts in accordance with the “M/Chip” standard promulgated by the assignee hereof and/or in accordance with the above-mentioned EMV standard. The load device 204 may encrypt the script using the above-mentioned off-line master encryption key. More specifically, the load device 204 may use a derived indexed load key associated with a payment application program that runs in the load device. The derived load key is used to generate a dynamic session key used in secure messaging with a payment application that runs in the cash card 202.

Step 1212 follows step 1210. At step 1212, the load device 204 transmits the encrypted script to the cash card 202. Thereafter, at 1214, the load device 204 receives a message from the cash card 202 to confirm that the cash card 202 has executed the script, thereby accomplishing the desired load of pre-authorized funds into the cash card 202. The process then ends, as indicated at 1216. (If the confirmation message is not received within a certain amount of time, then an exception handling process—which is not represented in the drawing—may be initiated.)

It will be understood that before providing the confirmation message, the cash card 202 executes the script received from the load device 204. The execution of the script may be similar to execution of a top-up script as called for by the above-mentioned M/Chip standard and/or the EMV standard. Upon execution of the script, the pre-authorized amount stored in the cash card 202 is increased by the amount of the load transaction, thereby increasing the balance available for purchase transactions with the cash card 202.

Subsequent to the off-line load transaction, and possibly in an end of day batch operation, notification of the off-line load transaction is provided (e.g., from the load device 204 via the acquirer 210—FIG. 2) to the cash card system host computer 208. The cash card system host computer 208 then updates the account record for the cash card 202 to reflect the off-line load transaction. A later clearing transaction results in a transfer of the funds collected by the merchant to the card issuer. In addition or alternatively, the clearing transaction itself provides the notification of the off-line load transaction to the cash card system host computer 208.

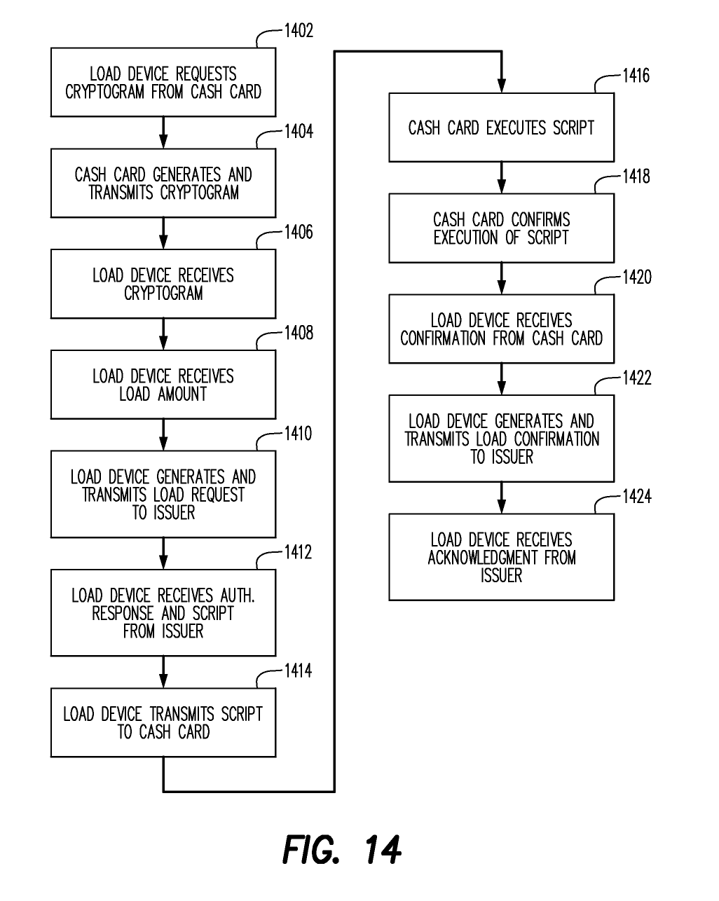

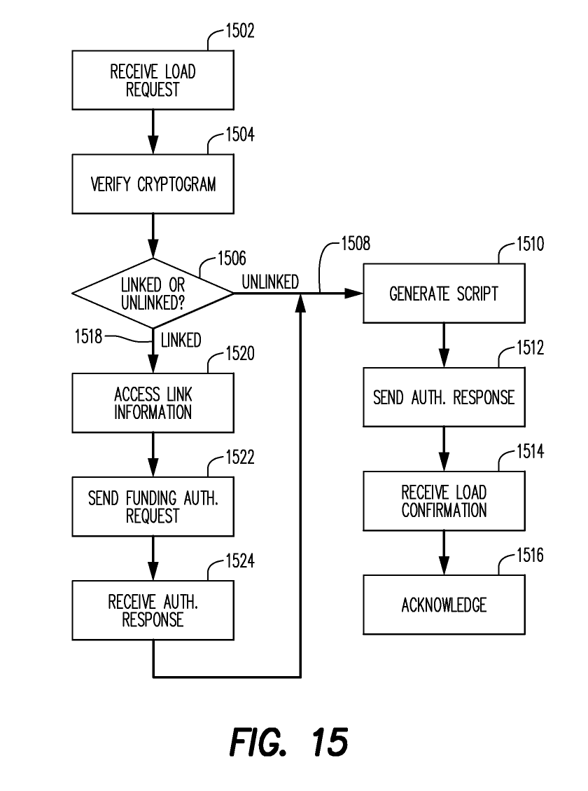

FIG. 13 is a flow chart that illustrates an on-line load process that may be performed in the payment card system 100 in accordance with aspects of the present invention.

At 1302 in FIG. 13 (and referring also to FIG. 3), the cardholder 200 interfaces the cash card 202 to the load device 204. As noted above this may be done via the contacts 808 (FIG. 8) on the cash card 202 and via the card interface 902 (FIG. 9) of the load device 204. It should also be noted that instead of the cardholder interfacing the cash card 202 to the load device 204, this action may be performed by an employee (not shown) of a merchant, bank or service provider.

Following block 1302 is a decision block 1304. At decision block 1304, it is determined whether or not the on-line load is to based on a link between the cash card 202 and another account (e.g., a credit or debit card account) that belongs to the cardholder 200. That is, it is determined at decision block 1304 whether the current load transaction is to be funded from a linked account, or is to be funded with cash tendered by the cardholder 200. This determination may be made based on input provided to the load device 204 by the operator (merchant/bank/service provider employee), and may reflect a dialogue between the operator and the cardholder in which the cardholder indicates whether he/she desires linked or cash funding for the on-line load transaction. As part of decision block 1304, if the cardholder requests a linked on-line load transaction, the load device 204 may receive a “link status indication” from the cash card 202. The link status indication is a data element stored in the cash card 202 which indicates whether the cash card 202 is linked to another account. It may be the case that the on-line load transaction will be allowed to proceed on a linked basis only if the link status indication indicates that the cash card 202 is linked to another account.

However, in other embodiments, the determination made at decision block 1304 is made entirely on the basis of the link status indication. That is, if the link status indication indicates that the cash card 202 is linked to another account, then the on-line load transaction automatically proceeds on a linked basis. If the link status indication indicates that the cash card 202 is not linked to another account, then a cash tender from the cardholder is required, and the load transaction must occur on an unlinked basis.

If it is determined at decision block 1304 that the on-line load transaction is not to be via funding from a linked account, then the process of FIG. 13 advances via branch 1306 from decision block 1304 to block 1308.

At 1308 in FIG. 13, the cardholder 202 delivers and the merchant/bank/service provider employee receives cash to cover the requested amount of the desired on-line load transaction. (It will be evident that step 1308 may be performed prior to or as part of decision block 1304.)

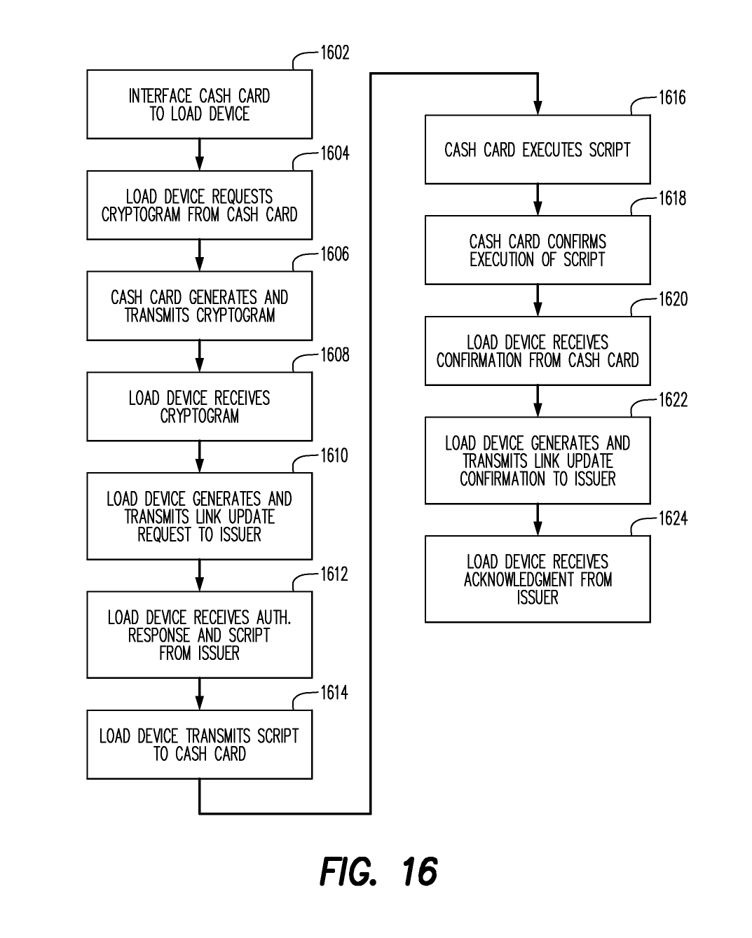

Following block 1308, is block 1310. At block 1310, an on-line load transaction takes place, without a further funding transaction from a linked account. FIG. 14, which is discussed below, provides details of the unlinked on-line load transaction from the point of view of the load device 204 and the cash card 202; and FIG. 15, which is also discussed below, provides details of the unlinked on-line load transaction from the point of view of the cash card system host computer 208.

If it is determined at decision block 1304 that the on-line load transaction is to be via funding from a linked account, then the process of FIG. 13 advances via branch 1312 from decision block 1304 to block 1314.

At block 1314, an on-line load transaction takes place, in conjunction with a further funding transaction from the linked account. FIGS. 14 and 15 provide details of the linked load transaction, from the points of view of the load device 204 and the cash card system host computer 208, respectively.

FIG. 14 is a flow chart that illustrates some details of the process of FIG. 13. In particular, FIG. 14 illustrates operations performed by the load device 204 and the cash card 202 and illuminates aspects of blocks 1310 and 1314 in FIG. 13.

At 1402 in FIG. 14, the load device 204 requests the cash card 202 to provide a cryptogram to authenticate the cash card 202 for the desired on-line load transaction. At 1404, the cash card 202 generates the requested cryptogram and transmits it to the load device 204. At 1406, the load device 204 receives the cryptogram from the cash card 202. (Reference is made to the above discussion of steps 1202-1206—FIG. 12. That discussion is pertinent to steps 1402-1406 and provides additional detail as to the manner in which steps 1402-1406 may be performed.)

At 1408 in FIG. 14, the load device 204 receives input from the operator (i.e., the employee of the merchant/bank/service provider) to indicate the amount of pre-authorized funds to be loaded into the cash card 202. Presumably, this amount reflects an amount communicated orally from the cardholder to the operator of the load device 204. In the case of an unlinked on-line load transaction, the amount entered by the operator would also reflect the amount of cash tendered by the cardholder. (In various embodiments, input of the amount to be loaded may occur after, prior to or overlapping in time with the steps illustrated at 1402-1406.)

At 1410 in FIG. 14, the load device 204 generates and transmits to the cash card system host computer 208 (via the acquirer 210, FIG. 3) a request message in which the load device 204 requests the desired on-line load transaction. The request message may indicate the PAN for the cash card 202, the amount of pre-authorized funds to be loaded into the cash card 202, and an indication as to whether or not the requested on-line load transaction is to be funded from a linked account. The request message in this case may be in the nature of an authorization request message, which may also be referred to as an “authorization message”. As will be seen, with the authorization message, the load device 204 is effectively requesting from the cash card system host computer 208 a script to be executed by the cash card 202. The authorization message may also include the cryptogram generated by the cash card 202 and transmitted to the load device 204.

Thereafter, at 1412, the load device 204 receives an authorization response from the cash card system host computer 208. Assuming that the cash card system host computer 208 found everything to be in order with the request message, the authorization response includes a script to be executed by the cash card 202 to accomplish the desired load transaction. The script may be similar to the script as referred to in connection with step 1210 above, except that in the case of the script received at step 1412, the script may have been generated by the cash card system host computer 208 and encrypted by the cash card system host computer 208 with the on-line load transaction master key.

At 1414 the load device 204 transmits the script received at step 1412 to the cash card 202. At 1416 the cash card 202 executes the script so as to increase the amount of pre-authorized funds stored in the cash card 202. At 1418 the cash card 202 sends to the load device 204 a confirmation that the cash card 202 has executed the script, resulting in the desired load of pre-authorized funds into the cash card 202. At 1420, the load device 204 receives the confirmation from the cash card 202.

At 1422, the load device 204 generates and transmits to the cash card system host computer 208 another message, also in the form of an authorization message. However, in this case the authorization message is simply for the purpose of confirming to the cash card system host computer 208 that the desired load transaction has been performed successfully. Then, at 1424 the load device 204 receives from the cash card system host computer 208 an acknowledgement of the authorization (confirmation) message transmitted by the load device 204 at step 1422.

It will be appreciated that in a case where the on-line load transaction is not on a “linked” basis (i.e., where the load transaction is not funded from an account linked to the cash card 202), a subsequent clearing operation will transfer to the card issuer the funds collected by the merchant from the cardholder.

It should also be noted that the communications described above between the load device 204 and the cash card system host computer 208 may all occur via the acquirer 210 (FIG. 3) and via a payment card system network (not shown in FIG. 3) such as the Banknet network operated by the assignee hereof.

In some embodiments, every linked load transaction for a given cash card is in a set amount that is pre-arranged between the cardholder and the card issuer. In such embodiments, step 1408 may be omitted from the process of FIG. 14 for on-line load transactions performed funded on a linked basis. It may also be the case that a linked load transaction requires compliance with a cardholder verification method (CVM) such as entry of a PIN (personal identification number) by the cardholder and verification of the PIN.

FIG. 15 is a flow chart that illustrates aspects of the on-line load process as performed by the cash card system host computer 208 in accordance with aspects of the present invention. That is, FIG. 15 illustrates aspects of steps 1310 and 1314 of FIG. 13.

At 1502 in FIG. 15, the cash card system host computer 208 (acting in a role on behalf of the card issuer, and thus performing an issuer function and acting in an issuer mode) receives the authorization message (on-line load transaction request) that the load device 204 transmitted to the cash card system host computer 208 via acquirer 210 (FIG. 3) at step 1410 (FIG. 14). Continuing to refer to FIG. 15, at 1504 the cash card system host computer 208 verifies the cryptogram that the cash card 202 generated at step 1404 and that was included in the on-line load transaction request received by the cash card system host computer 208 at 1502. The verification of the cryptogram at 1504 by the cash card system host computer 208 may be performed in the same manner or in a manner similar to the cryptogram verification performed by the load device 204 (step 1206, FIG. 12) in the case of an off-line load transaction. At about the same time that the cash card system host computer 208 verifies the cryptogram, it may also verify that there is a valid record in the account management system for the cash card PAN included in the authorization message.

At decision block 1506 in FIG. 15, the cash card system host computer 208 determines whether the on-line load transaction has been requested on a linked or unlinked basis. The cash card system host computer 208 may make this determination based on an indication included in the on-line load transaction request received at 1502.

In the case where the requested on-line load transaction is unlinked, then the process of FIG. 15 advances via branch 1508 from decision block 1506 to block 1510. At block 1510 the cash card system host computer 208 generates the script that was referred to above in connection with steps 1412-1416 in FIG. 14. The cash card system host computer 208 may encrypt the script with the on-line load transaction master encryption key that was referred to above in connection with FIG. 10.

At 1512, the cash card system host computer 208 sends to the load device 204 (via the payment card system network and the acquirer) an authorization response that includes the script generated and encrypted by the cash card system host computer 208 at 1510. At 1514, the cash card system host computer 208 receives from the load device 204 the authorization (confirmation) message referred to at step 1422 in FIG. 14. As noted above, the latter authorization message confirms to the cash card system host computer 208 that the requested on-line load transaction has been performed successfully. At 1516 in FIG. 15, the cash card system host computer 208 sends to the load device 204 an acknowledgement of the second authorization message (as mentioned above in connection with step 1424, FIG. 14).

It will be noted that the cash card system host computer 208 is operated in what is essentially an issuer mode (on behalf of the card issuer) in performing steps 1510-1516.

Referring again to decision block 1506, if the cash card system host computer 208 determines that the on-line load transaction has been requested on a linked basis, then the process of FIG. 15 advances via branch 1518 from decision block 1506 to block 1520.

At block 1520, the cash card system host computer 208 accesses information that indicates a credit or debit card account or other account that is linked to the cash card 202. The cash card system host computer 208 may access this information by using the PAN for the cash card 202. At 1522, and acting in an acquirer mode, the cash card system host computer 208 sends an authorization request to the issuer (reference numeral 304, FIG. 3) of the cash card 202 to request a transaction in which the linked account is charged to fund the requested on-line load transaction. This authorization request (step 1522) may be sent from the cash card system host computer 208 to the card issuer 304 via the above-mentioned payment card system network.

At 1524 the cash card system host computer 208 (continuing to act in an acquirer mode) receives an authorization response from the card issuer. Assuming that all was in order with the requested linked funding transaction, as indicated by the authorization response received at 1524, then the process continues with the above-described steps 1510-1516 by which the cash card system host computer 208 causes the requested on-line load transaction to be accomplished.

For any given cash card 202, the card may be loaded on a number of occasions via an off-line load transaction as described above, and on a number of other occasions may be loaded via an on-line (linked or unlinked) load transaction, as described above. On different occasions a given cash card may be loaded using different load devices among the numerous load devices that may be included in the payment card system 100.

FIG. 16 is a flow chart that illustrates a link update process that may be performed in the payment card system 100 in accordance with aspects of the present invention. The purpose of the link update process is to change/update the link status indicator that is stored in the cash card 202, as referred to above in connection with block 1304 (FIG. 13). The link status indicator may need to be updated, for example, if the cash card 202 has not previously been linked to another account, but the cardholder desires that such a link be made, and the cardholder makes arrangements accordingly with the card issuer. Conversely, updating of the link status indicator stored in the cash card 202 may also be necessary when the cardholder desires to sever an existing link between the cash card 202 and another account (e.g., if the cardholder is closing the linked account). Typically, for example, the cardholder may visit a branch location of the card issuer and meet with an employee of the card issuer to arrange for the link between the cash card 202 and an account owned by the cardholder (perhaps this occurs upon the occasion of the opening of the account with which the link is to be made). As part of the interaction between the cardholder and the bank employee, the bank employee updates the records at the cash card system host computer 208 and the card issuer's own records, and the bank employee also operates a load device 204 or similar device at the branch location to perform the process illustrated in FIG. 16.

Turning then to FIG. 16, at 1602 the bank employee interfaces the cash card 202 to the load device 204. This may be done via the contacts 808 (FIG. 8) on the cash card 202 and via the card interface 902 (FIG. 9) of the load device 204.

At 1604, the load device 204 requests the cash card 202 to provide a cryptogram to authenticate the cash card 202 for the desired link status indicator update transaction. At 1606, the cash card 202 generates the requested cryptogram and transmits it to the load device 204. At 1608, the load device 204 receives the cryptogram from the cash card 202. (Reference is made to the above discussion of steps 1202-1206—FIG. 12. That discussion is pertinent to steps 1604-1608 and provides additional detail as to the manner in which steps 1604-1608 may be performed.)

At 1610, the load device 204 generates a request to update the link status indicator stored in the cash card 202. This may occur, for example, in response to the bank employee selecting a suitable menu option by interacting with the user interface of the load device 204. Also as part of step 1610, the load device 204 transmits the link status update request to the cash card system host computer 208.

At 1612, the load device 204 receives an authorization response from the cash card system host computer 208. Assuming that the cash card system host computer 208 found everything to be in order with the request message (and with the records of the cash card system host computer 208 relative to the cash card account), the authorization response includes a script to be executed by the cash card 202 to accomplish the desired link status indicator update. The script may have been generated by the cash card system host computer 208 and encrypted by the cash card system host computer 208 with the on-line load transaction master key.

At 1614, the load device 204 transmits the script received at step 1612 to the cash card 202. At 1616 the cash card 202 executes the script so as to change/update the link status indicator stored in the cash card 202. At 1618 the cash card 202 sends to the load device 204 a confirmation that the cash card 202 has executed the script, resulting in the desired updating of the link status update stored in the cash card 202. At 1620, the load device 204 receives the confirmation from the cash card 202.

At 1622, the load device 204 generates and transmits to the cash card system host computer 208 another message, also in the form of an authorization message. However, in this case the authorization message is simply for the purpose of confirming to the cash card system host computer 208 that the desired link status indicator update has been performed successfully. Then, at 1624 the load device 204 receives from the cash card system host computer 208 an acknowledgement of the authorization (confirmation) message transmitted by the load device 204 at step 1622.

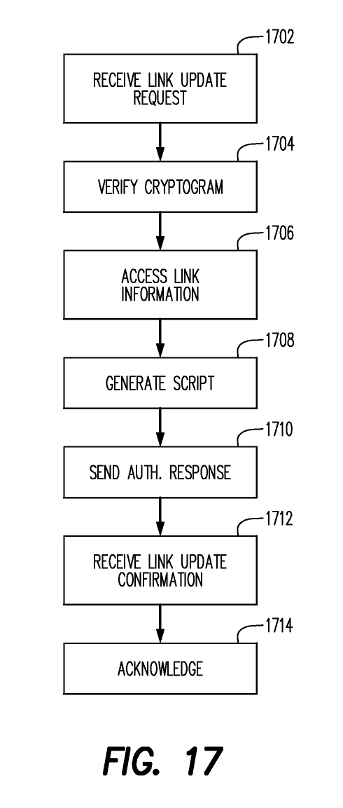

FIG. 17 is a flow chart that illustrates aspects of the link update process as performed by the cash card system host computer 208 in accordance with aspects of the present invention.

At 1702 in FIG. 17, the cash card system host computer 208 receives the authorization message (link status indicator update request) that the load device 204 transmitted to the cash card system host computer 208 at step 1610 (FIG. 16). Continuing to refer to FIG. 17, at 1704 the cash card system host computer 208 verifies the cryptogram that the cash card 202 generated at step 1604 and that was included in the link status indicator update request received by the cash card system host computer 208 at 1702. The verification of the cryptogram at 1704 by the cash card system host computer 208 may be performed in the same manner or in a manner similar to the cryptogram verification performed by the cash card system host computer 208 (step 1504, FIG. 15) in the case of an on-line load transaction.

At 1706, the cash card system host computer 208 accesses information in its records relative to the cash card 202 and any link or absence of a link between the cash card 202 and another account owned by the cardholder. Assuming that the information accessed by the cash card system host computer 208 at 1706 is consistent with the requested link status indicator update, then block 1708 follows block 1706.

At 1708, the cash card system host computer 208 generates the script that was referred to above in connection with steps 1612-1616 in FIG. 14. The cash card system host computer 208 may encrypt the script with the on-line transaction master encryption key that was referred to above in connection with FIG. 10.

At 1710, the cash card system host computer 208 sends to the load device 204 (via the payment card system network and the acquirer) an authorization response that includes the script generated and encrypted by the cash card system host computer 208 at 1708. At 1712, the cash card system host computer 208 receives from the load device 204 the authorization (confirmation) message referred to at step 1622 in FIG. 16. As noted above, the latter authorization message confirms to the cash card system host computer 208 that the requested link status indicator update has been performed successfully. At 1714 in FIG. 17, the cash card system host computer 208 sends to the load device 204 an acknowledgement of the second authorization message (as mentioned above in connection with step 1624, FIG. 16).

It should be understood that the communication between the load device 204 and the cash card system host computer 208 in connection with the processes of FIGS. 16 and 17 may be via the payment card system network. It will also be appreciated that there may be a computer on the card issuer side of the payment card system network acting as an intermediary between the load device 204 and the payment card system network/cash card system host computer 208.

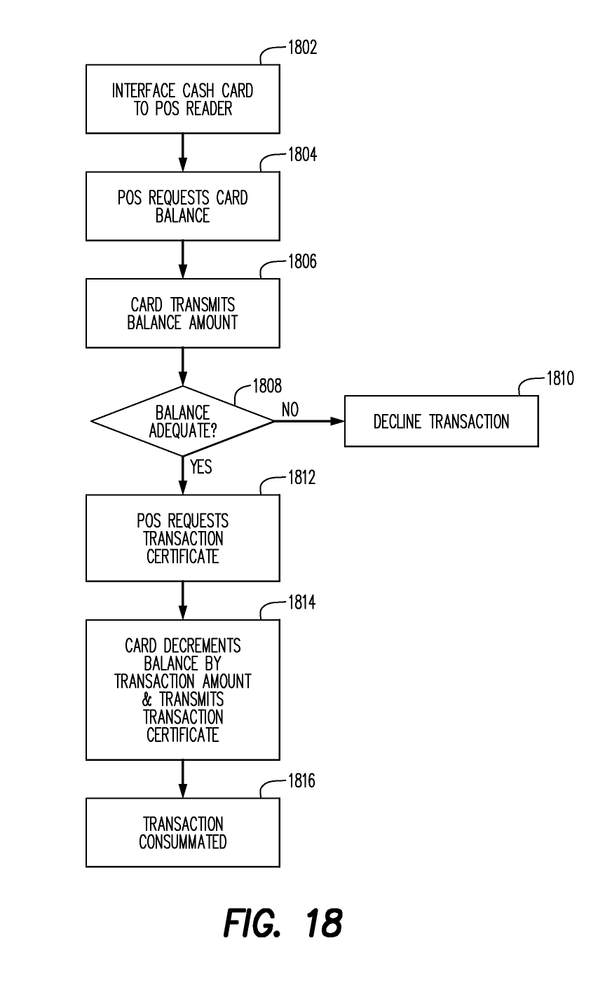

FIG. 18 is a flow chart that illustrates a process for a typical off-line purchase transaction performed in the payment card system 100 using a cash card 202.

For purposes of FIG. 18, it will be assumed that the cardholder is requesting a conventional purchase transaction, such as the purchase of an item at a retail store, or an unattended purchase, such as at a vending machine, parking meter, transit access, etc. In the case of a purchase of an item or items at a retail store, it may also be assumed that one or more items are scanned at the point of sale to generate a total purchase price for the transaction to be settled by use of the cash card 202.

Referring to FIG. 4 as well as FIG. 18, at 1802 in FIG. 18 the cardholder 200 interfaces the cash card 202 to the POS terminal 404 via the POS reader 402. In a preferred, most convenient mode of performing this step, the cash card 202 interacts with the POS reader 402 by wireless RF communication, i.e., in a “contactless” manner. In one practical embodiment, this is done by the cardholder 200 simply tapping the cash card 202 at a designated point on the reader 402, in accordance with conventional practices. Even though tapping occurs, this is still considered a “contactless” or “proximity” mode of operation, because in this mode the cash card 202 is not interfaced to the reader 402 via the contacts 808 (FIG. 8) of the cash card 202.

In an alternative mode of performing this step 1802, the cash card 202 is interfaced to the POS reader 402 via the contacts 808 and via a contact interface (not separately shown in FIG. 4) of the POS reader 402.

Conventional handshaking/mutual authentication may occur upon the cash card 202 being brought into proximity of/being interfaced to the reader 402. In addition, as indicated at 1804 in FIG. 18, the POS terminal 404 may request that the cash card 202 provide its current pre-authorized balance. The cash card 202 may respond, as indicated at 1806, by transmitting its pre-authorized balance to the POS terminal 404.

At decision block 1808, the POS terminal 404 determines whether the pre-authorized balance in the cash card 202 is sufficient to cover the amount due for the purchase transaction. If not, the POS terminal 404 declines the transaction, as indicated at 1810. Alternatively, if the pre-authorized balance is sufficient, then block 1812 follows decision block 1808.

At 1812 the POS terminal 404 requests a transaction certificate from the cash card 202 to cover the amount of the transaction. This may be done in a conventional manner. Next, at 1814, the cash card 202 decrements its pre-authorized balance by the amount of the transaction and transmits the requested transaction certificate to the POS terminal 404. This too may be accomplished in accordance with conventional practices.

At this point the purchase transaction has been consummated, as indicated at 1816, and the cardholder is free to remove his/her purchase from the retail store.

In a subsequent (e.g., end of day batch) process, illustrated in FIG. 4 and discussed hereinabove in connection with FIG. 4, the merchant collects the amount of the purchase (less any fees) via a clearing process through the merchant's acquiring financial institution and the clearing system, with the funds cleared from the issuer of the cash card 202.

A purchase transaction using the cash card 202 may take less time, and hence be more efficient, than a similar transaction in which cash is exchanged. Purchasing with the cash card 202 may also be advantageous in other ways. For example, the cash card 202 may maintain a log of purchases (or at least of recent purchases).

In some embodiments, the cash card 202 may be used for a purchase transaction even when the pre-authorized balance is less than the amount of the transaction. This may be done by combining, for example, a linked on-line load transaction with the purchase transaction, as illustrated in FIG. 5, as discussed above. For such a combined transaction, it is likely to be necessary to interface the cash card 202 to the POS reader via the contact interface.

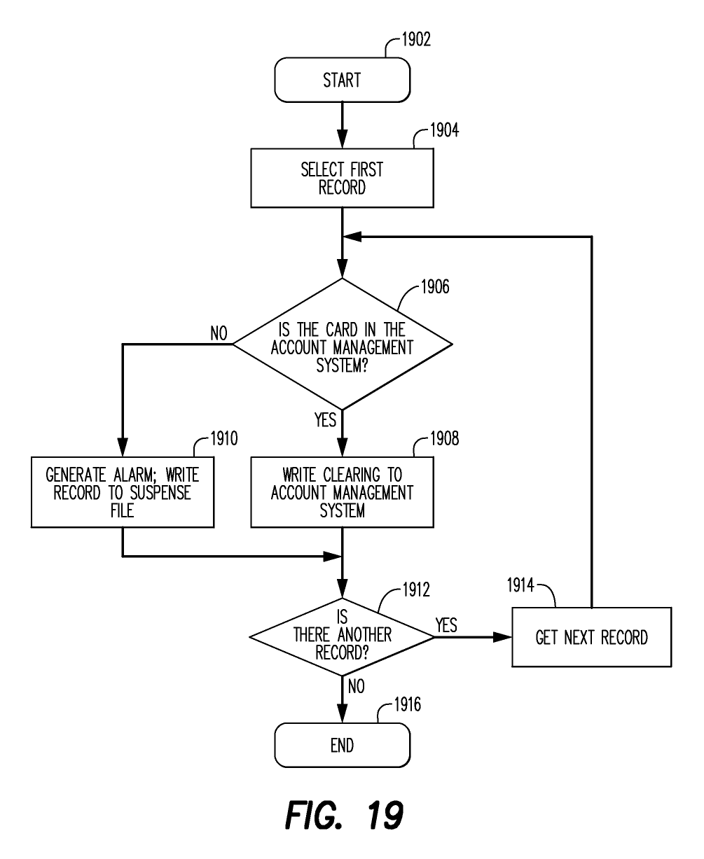

FIG. 19 is a flow chart that illustrates a process for clearing transactions performed by the cash card system host computer 208.

The process of FIG. 19 starts at 1902 and then advances to block 1904. At block 1904, the cash card system host computer 208 selects the first transaction record in a batch of transactions that has been submitted for clearing. Then, at decision block 1906, the cash card system host computer 208 determines whether the PAN included in the transaction record identifies a cash card for which an active account record is present in the account management system 554 (FIGS. 5A and 6). If so, then block 1908 follows decision block 1906. At block 1908, the transaction is entered against the cash card account record in question and is included for advisement to the card issuer and clearing of funds.

Considering decision block 1906 again, if it is determined in that decision block that there is no active account record for the PAN included in the transaction, then block 1910 follows decision block 1906. At block 1910, the cash card system host computer 208 generates an alarm to indicate that an invalid PAN has been submitted, and the current transaction record is written to a suspense file.

Decision block 1912 follows block 1908 or 1910, as the case may be. At decision block 1912, the cash card system host computer 208 determines whether there are any more records to be processed in the current batch of transaction records. If so, then at block 1914, the cash card system host computer 208 selects the next transaction record in the batch, and the process of FIG. 19 loops back from block 1914 to decision block 1906.

However, if at decision block 1912 the cash card system host computer 208 determines that there are no more records in the batch, then the process of FIG. 19 ends, as indicated at 1916.

In some embodiments, the cash card 202 may also include functionality for conventional credit and/or debit card purchase transactions. For example, the cash card 202 may store a first application program for implementing pre-authorized, cleared payments, as described herein, and a second application program for implementing a conventional contact or contactless credit card. The first application may store and transmit a PAN which identifies the pre-authorized and cleared payment account, while the second application may store and transmit a conventional credit card account PAN. It will be recognized that the two PANs would be different from each other. The second application program may alternatively store and transmit a PAN that identifies a conventional debit card account. The debit or credit card account may in some embodiments be the “linked” account referred to above, for example, in connection with FIG. 15. In some embodiments, each type of POS terminal or POS reader is operable only with one of the two applications, so that selection of one of the PANs/applications for a particular transaction occurs automatically as a consequence of the type of POS terminal/reader to which the card is presented. In other embodiments, a given POS may be operable with either type of application. In some embodiments, the application/PAN to be used for a particular transaction may be selected by the cardholder actuating one or more switches (not shown) on the card itself. In other embodiments, the application/PAN to be used for a particular transaction may be selected by input to the POS terminal/reader.

Among other technical effects provided by this invention, a device operated at a point of interaction with a user is programmed to generate a script that in turn programs an IC payment card to be loaded with pre-authorized funds.

In some embodiments, the cash card may be used for other applications, such as location access or customer loyalty, in addition to one or more payment applications.

Where the cash card is operable in one or more payment applications (e.g., to access a debit card account and/or a credit card account) in addition to the above-described pre-authorized and cleared payment application (the “cash card application”), there are a number of ways in which a particular one of the payment applications may be selected for a given transaction. In some embodiments, for example, the POS terminal or the cash card may automatically select the cash card application for transactions below a certain monetary amount limit and may select the credit or debit card application for transactions above the monetary amount limit. In other embodiments, the selection among payment applications may be made automatically based on the merchant's category code. In other embodiments, the user/POS terminal operator may be prompted by the POS terminal to select the application by manual input into the POS terminal.

In some embodiments, issuer functions described herein as being performed by the cash card system host computer 208 may alternatively be performed by the card issuer itself or by a computer operated on behalf of the issuer but other than the cash card system host computer 208.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

A transaction should be understood as being performed “on an on-line basis” if performing the transaction requires communication with a remote device. Conversely, a transaction should be understood as being performed “on an off-line basis” if performing the transaction does not require communication with a remote device.

Any block in a block diagram in the accompanying drawings that indicates an entity such as a merchant, an acquirer or an issuer should also be understood to represent one or more computers operated by or on behalf of such entity.

The term “issuer computer”, as used in the appended claims, includes a computer operated by a card issuer, or a computer (such as the cash card system host computer) operated on behalf of a card issuer.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of loading pre-authorized funds into an integrated circuit (IC) payment card, the method comprising:
interfacing the IC payment card to a loading device;
receiving a cash payment to cover a proposed load transaction; and
operating the loading device to load pre-authorized funds into the IC payment card on an off-line basis.
wherein:
the operating step includes the loading device generating a script and transmitting the script to the IC payment card; and
the IC payment card executes the script to increase a quantity of pre-authorized funds stored in the IC payment card.

2. The method of claim 1, wherein the interfacing step occurs via a contact interface on the loading device.

3. The method of claim 1, wherein the interfacing occurs via a contactless interface on the loading device.

4. The method of claim 1, wherein the loading device is a first loading device; and further comprising:
interfacing the IC payment card to a second loading device; and
operating the second loading device to load pre-authorized funds into the IC payment card on an on-line basis.

5. The method of claim 4, wherein:
the script is a first script;
the step of operating the second loading device includes receiving a second script from a remote computer, said step of operating the second loading device also including transmitting the second script to the IC payment card; and
the IC payment card executes the second script to increase the quantity of pre-authorized funds stored in the IC payment card.

6. The method of claim 5, wherein:
the loading device encrypts the first script by using a first master encryption key; and
the remote computer encrypts the second script by using a second master encryption key that is different from the first master encryption key.

7. The method of claim 5, wherein:
the second loading device transmits a first authorization message to the issuer computer to request the second script;
the second loading device receives the second script from the issuer computer in an authorization response message transmitted by the issuer computer; and
the second loading device transmits a second authorization message to the issuer computer to confirm execution of the second script by the IC payment card.

8. The method of claim 5, wherein:
the second loading device transmits a first authorization request to an acquirer computer;
the acquirer computer transmits the first authorization request to a card system host computer, said card system host computer being said remote computer;
the card system host computer, acting in an issuer mode, receives the first authorization request and verifies a cryptogram in the first authorization request; and
the card system host computer, acting in an acquirer mode, transmits a second authorization request to an issuer computer to request a charge against an account that is linked to the IC payment card.

9. The method of claim 4, further comprising:
the IC payment card transmitting to the second loading device a link status indication that is stored in the IC payment card, the link status indication indicating whether the IC payment card is linked to a cardholder account at an issuer bank.

10. The method of claim 9, further comprising:
interfacing the IC payment card to an issuer interface device; and
exchanging messages via the issuer interface device between the IC payment card and an issuer computer operated by or on behalf of the issuer bank, the messages for changing the link status indication stored in the IC payment card.

11. A method of loading pre-authorized funds into an integrated circuit (IC) payment card, the method comprising:
interfacing the IC payment card to a loading device;
transmitting a first authorization message from the loading device to a remote computer to request a script;
receiving the script from the remote computer in an authorization response;
executing the script in the IC payment card to increase a quantity of pre-authorized funds stored in the IC payment card; and
transmitting a second authorization message to the remote computer to confirm execution of the script by the IC payment card.

12. The method of claim 11, further comprising:
receiving, from the remote computer, an acknowledgment of the second authorization message.

13. The method of claim 11, further comprising:
transmitting the script from the loading device to the IC payment card.

14. The method of claim 13, further comprising:
receiving from the IC payment card, by the loading device, confirmation of execution of the script by the IC payment device.

15. A method of operating an IC payment card, the method comprising:
interfacing the IC payment card to a loading device;
the IC payment card transmitting to the loading device a link status indication that is stored in the IC payment card, the link status indication indicating whether the IC payment card is linked to a cardholder account at an issuer bank;
interfacing the IC payment card to an issuer interface device operated by or on behalf of the issuer bank; and
exchanging messages via the issuer interface device between the IC payment card and an issuer computer operated by or on behalf of the issuer bank, the messages for changing the link status indication stored in the IC payment card.

16. The method of claim 15, wherein the exchanged messages include a script downloaded from the issuer computer to the IC payment card via the issuer interface device.

17. The method of claim 16, further comprising:
the IC payment card executing the downloaded script to change the link status indication stored in the IC payment card.

18. The method of claim 17, further comprising:
the IC payment card confirming execution of the script to the issuer computer via the issuer interface device.

19. The method of claim 18, wherein the issuer interface device transmits confirmation of execution of the script to the issuer computer in a message format used for authorization messages in a payment card system.

20. The method of claim 19, wherein the issuer computer acknowledges the confirmation of execution of the script.

21. A method of operating an IC payment card system, the method comprising:
providing a first master encryption key to an issuer computer;
providing a second master encryption key to a plurality of loading devices located remotely from the issuer computer, the second master encryption key different from the first master encryption key;
using the first master encryption key to encrypt first scripts, the first scripts for loading pre-authorized funds into IC payment cards in online load transactions; and
using the second master encryption key to encrypt second scripts, the second scripts for loading pre-authorized funds into the IC payment cards in offline load transactions at the loading devices.

22. The method of claim 21, wherein at least some of the online load transactions are performed at the loading devices at which the offline load transactions are performed.

23. The method of claim 21, wherein at least some of the online load transactions are performed at devices other than the loading devices at which the offline load transactions are performed.
